(19) United States
(12) Patent Application Publication
(10) Pub. No.: US 2002/0097193 A1
(43) Pub. Date: Jul. 25, 2002

(54) System and method to increase the efficiency of outdoor advertising

(75) Inventor: Keith Powers, Los Angeles, CA (US)

Correspondence Address: HOGAN & HARTSON L.L.P., 500 S. GRAND AVENUE, SUITE 1900, LOS ANGELES, CA, 90071-2611, US

(73) Assignee: FreeCar Media

(21) Appl. No.: 09/767,618

(22) Filed: Jan. 23, 2001

(51) Int. Cl. G09G 5/00

(52) U.S. Cl. 345/2.3

(57) ABSTRACT

A method and system of determining and increasing the effectiveness of outdoor mobile advertising based upon monitoring, recording and communicating data representative of the operator and vehicle movement characteristics. The method comprises steps of monitoring a plurality of raw data elements representative of operating states of the vehicle or action of the operator. Selected ones of the raw data elements are recorded or transmitted when the ones are determined to have identified a relationship to a predetermined set of standards for use with outdoor mobile advertising. The selected ones are consolidated for processing against a vehicle, an operator, and an advertising client profile for identifying when and where to display an advertisement, for qualifying vehicles and vehicle drivers, for identifying a rate of charge to an advertising client, and for identifying a rate of compensation to a vehicle owner or operator for displaying the advertisement.

### FIELD OF THE INVENTION

The present invention relates generally to outdoor advertising and, more particularly, to a system and method of displaying advertising information on a vehicle for creating an efficient mobile outdoor-advertising medium.

### BACKGROUND OF THE INVENTION

The outdoor advertising is one of the most rapidly expanding segments of the whole advertising industry. Nevertheless, as the outdoor advertising continues to grow at an exponential speed, the supply of traditional outdoor advertising inventory is shrinking while the increased profitability in outdoor advertising is primarily resulting from higher prices of advertisements. For example, many municipalities have limited the number of billboards that can be placed within certain areas of the municipalities. Consequently, the supply of the traditionally fixed outdoor advertising inventory cannot catch up with the demand of outdoor advertising. In response to the limitation of the traditionally fixed outdoor advertising inventory, mobile outdoor advertising became more and more popular over the last decade because it provides virtually unlimited supply of moving billboards to a target market that is in need of additional outdoor advertising supply.

Conventionally, mobile advertisements or fleet graphics have been applied to commercial or personal vehicles of employees of a company that the messages they are advertising refer to. The messages or advertisements are applied on the vehicle with paint or, more recently, with adhesive vinyl-based materials. Over the last decade, the vinyl adhesive industry has improved graphic quality of advertisements printed on the vinyl films and has also improved the durability and handling properties of the vinyl films to make them the most widely-used media of producing outdoor advertisements and, in particular, vehicle graphics.

In 1993, SuperGraphics, Inc., a Silicon Valley based pioneer company in digital imaging, did the previously unthinkable by wrapping an entire bus with a new vinyl adhesive product introduced by 3M Company. This advertising trick instantly gained much popularity among many advertisers. In the beginning, bus wraps and the introduction of other creative outdoor advertising ideas, like mobile billboards and sailboat billboards, were all in response to the lack of available outdoor advertising space. Gradually, this trend has spread to large trucks as well. For example, many tractor-trailer owners have decorated their vehicle fleets with four-color photographic images to help sell their products and/or services. But this mobile advertisement trend has yet to spread to other privately owned vehicles. Accordingly, there is still an extremely limited supply of available data on the efficiency or impression rates attained by mobile vehicle advertisements. Understanding the value of mobile advertisements and wishing they had more detailed efficiency and/or impression rates data, advertisers therefore would like to know exactly where, how often and if their mobile advertisements are being seen by their target markets.

Conventionally, the advertising industry determines the effectiveness and a cost-per-impression (CPM) of traditional fixed-structure outdoor advertising, like a roadside billboard, by counting the number of people or vehicles that pass by the display. Based on data collected, each year the advertising industry publishes a book listing the impression rate data of selected locations. Likewise, the annual operational and other statistical or surveyed data of vehicles and/or operators of the vehicles are collected by the advertising industry. The data is then used against routes that the vehicles (e.g., the buses, taxis, trucks and/or cars) take in order to compile an estimate of impression rate for the mobile advertisement of the vehicles.

A principal problem with such conventional determination system is that much of the data gathered from vehicles or vehicle operators is not verifiable or even reliable. Moreover, existing records of these data contain only minimal and incomplete information. In other words, the current mobile outdoor advertising rating system is primarily based on a guessing game. None of the data obtained through the conventional determination system can reliably predict manners and/or locations of future operation of the vehicles. Accordingly, due to the limited amount of currently accumulated data and the minimal evidential value of the collected data towards computation of accurate impression rates in mobile outdoor advertising, the advertising industry has a long-felt need to improve the conventional mobile-advertising determination system. Specifically, the advertising industry needs a better determination system for accumulating more reliable and accurate data with a highly relevant evidential value towards more correctly predicting the operating characteristics of a vehicle at all times.

In addition, there is an overwhelming need to provide a business the ability to communicate in real-time to the general public or its target markets when it has idle services, overabundant products, or product capacities, etc. The current media and advertising methods fail to provide that real-time communication capability. Only recently have we seen this gap being partly reduced by the introduction of the real-time postings, sales, and bidding sites for idle capacities or products on the Internet. However, this limited real-time communication capability on the Internet is only a minor and partial solution to modem business needs for many companies.

Moreover, modem electronic systems installed in vehicles are often adaptable for obtaining desired vehicle operating data. For example, many electronic vehicle-tracking systems, such as a LoJack, installed in vehicles have already been widely used in monitoring the exact locations of the vehicles at any given time. Typically, an electronic vehicle-tracking system uses a communication link with one or more satellite navigation systems for providing information describing a vehicle's location based upon electronic navigation signals. When such positioning information is combined with roadmaps in an expert system, the vehicle location, the speed of the vehicle, and the route taken by the vehicle are all instantly ascertainable. Such vehicle operating information is very valuable and relevant to the mobile outdoor advertising. For instance, it can be used to more accurately determine when and where to display an advertisement, to qualify vehicles and vehicle drivers, to identify a rate of charge to an advertiser, and to identify a rate of compensation to a vehicle owner or operator for displaying the advertisement. However, none of the conventional mobile advertising system has fully utilized the electronic vehicle-tracking system for mobile advertising purposes. On the other hand, mere vehicle specific data alone, though, will not provide adequate data particularly relevant to what advertisement should be displayed or to the impression rate the advertisement received unless the data is combined with other relevant demographic and geographic data in an expert system which is capable of assessing and matching a vehicle and operator profile against an advertiser's profile, and then using the industry standards to calculate impression rates.

### SUMMARY OF THE INVENTION

An object of the present invention is to improve the arbitrary and unreliable problems of the conventional outdoor mobile advertising so as to provide a more effective outdoor mobile advertising. This object is accomplished by providing a method and/or a system in mobile advertisements using a vehicle monitoring, recording and communication system. The present invention is particular adaptable for monitoring air, water or land based vehicle operating characteristics and behaviors of the vehicle operators in real-time, for predicting future operating characteristics of vehicles, and for providing efficient and cost effective outdoor mobile advertising for advertising clients.

Accordingly, an embodiment of the present invention describes a method for providing outdoor mobile advertising, the method comprising the steps of generating vehicle information of a plurality of vehicles and storing the vehicle information in a database of a computer control system, displaying an advertising material on each one or more vehicles selected from the plurality of vehicles in the database, dynamically tracking and monitoring current vehicle operating characteristics and conditions of the selected vehicles, the current vehicle operating characteristics and conditions being used to update the selected vehicles' information in the database, periodically compensating designated operators of the selected vehicles based on actual vehicle operating characteristics and conditions, and periodically billing an advertising client at an advertising service rate for mobile advertising services provided to the advertising client, the advertising service rate being corresponding to compensation paid to the designated operators with added premium.

Another embodiment of the present invention provides that the advertising materials displayed on the selected vehicles are adapted to display different advertising messages in response to electronic signals received from the computer control system. The advertising messages displayed on the selected vehicles are based on advertising requests received from advertising clients. Thus, this embodiment according to the present invention offers advertising clients with the ability to display desired advertisements in real-time.

A third embodiment of the present invention describes a method of outdoor mobile advertising by providing vehicles at substantially reduced costs to designated vehicle operators. The designated vehicle operators are selected from a plurality of applicants based on information of the applicants and based on criteria of an advertising program. The vehicles are displayed with advertising materials.

Additional objects and advantages of the present invention will be set forth in the descriptions which follow, and in part will be obvious from the description, or may be learned by practice of the present invention. The objects and advantages of the present invention may be realized and obtained by means of the instrumentalities and combinations particularly pointed out in the appended claims.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to generally explain the principles of the present invention and not to limit the scope of the present invention in which:

FIG. 1 shows a flowchart illustrating an embodiment in accordance with the present invention;

FIG. 2 shows a vehicle tracking and communication system in accordance with the embodiment of FIG. 1;

FIG. 3 shows a flowchart generally describing a data-gathering process in accordance with the present invention; and

FIG. 4 shows a diagram illustrating implementation of the embodiment of the present invention in FIG. 1.

### DETAILED DESCRIPTION OF THE INVENTION

According to a preferred embodiment of the present invention, a mobile advertisement service provider (an MASP) generates an extensive database of vehicle information such as vehicle characteristics, vehicle operating characteristics, and personal information of the vehicle owners or operators. In the preferred embodiment, the vehicle information is collected through an Internet online registration form provided by the MASP and answered by an applicant, e.g., the vehicle owner or operator. In alternative embodiments, the vehicle information may also be collected over the telephone, by emails, or by paper registration forms submitted by applicants, etc.

The vehicle information submitted by each applicant must contain extensive information about the vehicle characteristics, the operating characteristics of the vehicle and the personal information of the vehicle owner(s) and operator(s). For example, the personal information may include vehicle owner's or operator's name, address, birthday, ID numbers (e.g., the social security number and the drive license number), educational background, personal and household incomes, driving record, name and address of his/her employer, history of employment, hobbies, purchasing patterns, vacation patterns, etc. The vehicle characteristics may include model, maker and year of the vehicle, maintenance and repair history, color, size, vehicle value and statute in a community, and accident record, if any, etc. The vehicle operating information may include average annual driving mileage, total movement time in minutes by each driver of the vehicle, number of minutes of vehicle movement in high/low impression locations (high/low populated and demographically different areas), number of minutes of vehicle movement at high/low impression times (rush hour or Sunday afternoon), where the vehicle is parked during the day/night, safe driving behavior, driving history, and total activities of the vehicle, etc. Basically, any information related to the vehicle and the vehicle owner/operator that may be helpful in determining whether or not to choose the applicant(s) as designated mobile advertisement driver(s) should be answered and recorded in the database.

In addition, survey or statistical information of a target market should be collected as well, such as typical and average age of the target market, income level of the target market, family size of the target market, work or school status of the target market, educational level of the target market, purchasing patterns of a typical vehicle owner in the target market, purchasing patterns of certain area codes or zip codes, weather and other local factors of the target market, special events in a local market, corresponding other advertising campaigns being promoted by an advertising client in certain markets, and the sales and other operational indicators of the advertising client in the target market. This survey or statistical information of the target market may be provided by a potential advertising client, obtained from a market research firm, or may be created from the MASP's own researches. Consequently, based on all the above information collected in the MASP's database, separate actuarial classes and/or tiers can be developed in the database for vehicles, for vehicle operators or owners, and for advertising clients to provide a means of tracking every one of them separately and of efficiently matching one to another.

Since these new and more precise actuarial classes and/or tiers are based on the actual uses of the vehicles and the behaviors demonstrated by the vehicle operators, they are considered to be much better predictors for identifying when and where to display an advertisement, for qualifying vehicles and vehicle owners or operators, for identifying rates of charge to an advertiser, and for identifying rates of compensation to the vehicle owners or operators. Accordingly, the method and system of the present invention will provide a more accurate, reliable, effective and cost-efficient way of mobile outdoor advertising to advertising clients. Moreover, the method and system according to the present invention will also allow the vehicle owners and operators unprecedented control over an ultimate compensation they can derive from using their vehicles as a platform for advertising.

According to the preferred embodiment, the present invention includes covering the exterior of a vehicle with advertising materials such as a vinyl adhesive wrap, one or more stickers, a product model or paint, glass, plastics, etc., and compensating the owner or operator of the vehicle for providing that vehicle space for advertising purposes. In addition, the advertising materials may be placed on the vehicle by replacing a part of the vehicle with advertisement bearing materials, by altering a part of the vehicle, or by adding or subtracting a part of the vehicle. The vehicle may be privately or commercially owned and may be air, water, or land based. Moreover, the vehicle is installed with an advanced vehicle tracking-and-communication system for tracking, monitoring, and recording actual movements of the vehicle, and for providing a communication channel between a central computer and communication system (the central control system) and the vehicle operator. The central control system is operated by either the mobile advertisement service provider (MASP) or by one or more third parties contracted with the MASP to provide control and communication services to the MASP.

The MASP compensates the vehicle owner or operator based on the actual operating characteristics of the vehicle, such as the vehicle usage, distance, time, locations of vehicle movements, and/or where the vehicle is based during periods of non-movement, etc. Methods of compensation to the vehicle owner or operator may include, but is not limited to, cash, stock or stock options, products, services, coupons, and use of a free vehicle, or any combination thereof, etc. The MASP then charges an advertising client with a predetermined schedule of rates for the mobile advertisement services provided to the advertising client. Generally, the rates charged to the advertising client correspond to the method of payment to the vehicle owner or operator with an added premium. Alternatively, such rates can also be sold to advertising clients in packages based on multiple vehicles or multiple campaigns.

A second embodiment of the present invention includes using the vehicle tracking-and-communication system in coordination with vehicle wrapping, covering or affixing materials that can alter their appearances based on one or more predetermined trigger events. In addition, the alterable materials may be placed on the vehicle by replacing a part of the vehicle, by altering a part of the vehicle, or by adding or subtracting a part of the vehicle. These alterable wrapping, covering or affixing materials include, but are not limited to, paper, electronic paper, vinyl, plastics, glass, metal and composites, electrical or electronic billboards, etc. For example, a recent invention of electronic paper by E Ink Corporation (the E-Ink) is one of the alterable materials suitable for the present invention. According to the present invention, a message displayed on the alterable material, such as the electronic paper, is adapted to be changed by an electronic signal from the central control system. Consequently, using the alterable material to wrap, cover or affix on the vehicle for advertising purposes, the present invention can therefore make the vehicle function as a real-time display-altering message board. In addition, the real-time communication and display-altering capability of the present invention provides business concerns tremendous advantages and flexibility in managing their business activities, such as providing them the abilities of communicating their idle capacities to a large population in real-time so as to reduce their idle capacities.

In the example of electronic paper by the E-Ink, a sheet of plastic paper is printed with electronic ink thereon and is laminated to a layer of circuitry. The circuitry forms a pattern of pixels that can then be controlled by a standard display driver. The electronic ink itself is a liquid that can be printed onto nearly any surface. Within the liquid are millions of tiny microcapsules, each one containing white particles suspended in a dark dye. When an electric field is applied at a spot of the electronic paper, the white particles within the microcapsules around the spot move to one end of the microcapsules where they become visible. This makes the surface of the electronic paper appear white at that spot. An opposite electric field pulls the white particles to the other end of the microcapsules where they are hidden by the dye. This makes the surface of the electronic paper appear dark at that spot. The electric field at each spot of the electronic paper is controlled by the circuitry forming a pattern of pixels. As a result, an image displayed on the electronic paper can be controlled by the circuitry, which in turn is controlled by signals remotely received from the central control system.

The present invention defines a plurality of trigger events for altering the messages displayed on selected vehicles based on certain information or events recorded in the database or based on received requests from advertising clients. When the central control system detects a trigger event has occurred, it will immediately send signals directing the alterable material, such as the electronic paper, to change an advertising message displayed on the alterable material according to the trigger event.

According to the present invention, the alterable material would wrap the vehicle exterior or cover parts of the vehicle for displaying advertisements. An example of a trigger event would be the movement of the vehicle from a parking lot of a supermarket to a main downtown intersection. In this example, the vehicle tracking-and-communication system would record and communicate the vehicle movement to the central control system or to an on-board computer of the vehicle and would generate an immediate response in the form of a signal to alter the display on the alterable material of the vehicle. When the central control system detects that the vehicle is located in the supermarket parking lot, it will cause the alterable material to display a product or service of an advertising client that wishes to communicate its message to a target population at the supermarket. When the central control system determines that the vehicle has moved from the supermarket parking lot to the downtown intersection, the central control system locates the same or another advertising client that is targeting a downtown population and will then trigger a response in the form of altering the display on the alterable material from, for example, a diaper advertisement to an advertisement for discounted tickets for a local movie offering.

Alternatively, the on-board computer of the vehicle can be preprogrammed with advertising messages and/or triggering information. The vehicle tracking-and-communication system works with the on-board computer to determine whether a pre-defined trigger event has occurred or not. If the predefined trigger event has occurred, the on-board computer will then direct the alterable material to display an advertising message according to the trigger event. For instance, once the vehicle tracking-and-communication system detects the vehicle being moving out of the supermarket parking lot and to the main downtown intersection, the on-board computer of the vehicle will automatically changes the display of the advertising message shown on the alterable material based on the pre-programmed advertising messages and triggering information.

In accordance with the second embodiment, the trigger mechanism may also be initiated by, for instance, movement of the vehicle, a manually triggered change or alteration from a remote location or from the vehicle, a change of time, a change in lighting, movement near the vehicle of other vehicle, movement of people or animals near the vehicle, changes in the weather, purchasing patterns in local stores, sales promotions and last minute sales promotions of an advertising client, or any world events or news-related items, etc.

In the above example, traveling from the supermarket parking lot to the downtown intersection by the vehicle will trigger the change of advertisements. In this example, the central control system communicates with the vehicle to alter the advertising display thereon to the discounted movie tickets at local movie theaters. While the vehicle owner or operator is shopping or driving out of the parking lot, the central control system may also communicate with a ticket sales computer of a local movie theater. Thus, based on a predetermined agreement with or conditions of the movie theater, e.g., the theater is less than 40% sold out with less than thirty minutes left before the show, the central control system may communicate with any vehicles within a specific radius of the theater and trigger the advertisement of the discounted tickets displayed on the alterable material in order to promote the remaining seats of the theater.

Likewise, the central control system can also be used to communicate any kinds of time- or location-sensitive product or service advertisements including, but not limited to, perishable goods at a supermarket, furniture sales, available rental cars/taxis, discounted hair cuts, any kinds of events or travel tickets, hotel room availability, appointment time at a physician's or dentist's office, and available painters, movers, carpenters, or pool cleaners, etc.

The central control system is preferably connected to the World Wide Web or the Internet to provide any potential advertising client the online ability to request advertising space as desired. In addition, the central control system may also receive advertising requests from the advertising clients based on pre-established communication relationships with the advertising clients. For instance, a pediatric doctor's office is informed that four people have canceled their afternoon appointments and the office has no waiting list for that afternoon. With the services provided by the MASP according to the present invention, the pediatric doctor's office would therefore be able to log onto the website and request that an advertisement be placed on any available vehicles within ten miles of the doctor's office or near any local schools. Instead of leaving the time idle for that afternoon, the pediatric doctor's office then poses a perfect opportunity to invite a potential new client into the office for the first time for a free check-up or for a free flu shot, etc. Accordingly, the office can request to display what they would like to communicate on the vehicle and the office will be instantly quoted a price by the MASP for any duration that the advertisement is displayed. A report will be generated at the end of the day or within a predetermined period in order to provide specific information related to the impression rate of the advertisement and the final pricing for that advertising period.

In accordance with yet another aspect of the present invention, the present invention also comprises the steps of generating calculated and/or derived data elements from information recorded in the database and the steps of accumulating the calculated and derived data elements in a recording device. Accordingly, the information stored in the database can be frequently updated based on new data recorded. For instance, with the help of the vehicle tracking-and-communication system, the present invention will use information acquired from the vehicles to more accurately assess the actual vehicle usage and thereby derive when and where an advertisement should be displayed and a fair rate and compensation structure. Based on historical data of each vehicle or operator profile, the present invention would further provide the ability for potential advertising clients to bid on specific vehicle space or on a grouping of vehicle space based on the advertising needs of such clients. This bidding mechanism could be managed via a secured World Wide Web or Internet platform, telephone, in person, or via any other modes of communication channels, either directly or indirectly, with the central control system.

Since the database, generated according to the present invention, can be frequently updated based on the actual operating characteristics of a vehicle, the actuarial classes and/or tiers offered by the present invention are considered to be much better predictors for identifying when and where to display an advertisement, for qualifying vehicles and vehicle drivers, for identifying a rate of charge to an advertiser, and for identifying a rate of compensation to a vehicle owner or operator, etc.

In accordance with another aspect of the present invention, additional compensation/discounts and surcharges can also be provided to the vehicle owner and operator based on data obtained from the vehicle operating characteristics and/or from the advertising client. Examples of surcharges and discounts based on the vehicle operating characteristics and advertising client-provided data include:

Surcharges:for any vehicle owner- or operator-generated advertisement they choose to display on the vehicle, and any excessive down-time that the vehicle might have due to the negligence of the vehicle owner or operator.

Compensation/discounts:Regular selection of low/high impression routes of travel, regular travel at low/high impression times, significant changes in operator behavior that results in lower impressions, vacation discount when the vehicle is not used, regular use of safety devices, and unfailing observance of speed limits.

Since there is some overlap between the data used for classifying the actuarial classes/tiers and for determining discounts/surcharges, the overlapping data needs to be gathered and analyzed first before a determination can be made about which vehicle-obtained data will be used to determine actuarial classes/tiers and which will be used for surcharges or discounts. Moreover, the present invention provides benefits of precise and timely information to accurately determine the operating characteristics of the vehicle, including such features as miles driven, time of use, and the speed of the vehicle. This information can be used to establish actual usage-based advertising charges.

It is another benefit of the present invention that most vehicle electronics can be easily supplemented by currently available or future electronic system components comprising a data recording device, a navigation system, and a communication device to extract selected operating characteristics, insurance and/or advertisement impression relevant data from the vehicle. Thus, the costs to implement the present invention on a vehicle would be minimum.

It is yet another aspect of the present invention to dynamically generate actuarial classes/tiers and operator profiles relative thereto based upon actual movement characteristics of selected vehicles and operators, as represented by the monitored and recorded data elements, for providing a more knowledgeable, enhanced precision advertising impression rating system. Accordingly, the present invention provides the new impression rating system for retrospectively adjusting and prospectively setting advertising premiums based on data obtained from vehicle operating characteristics and operator behaviors through the generation of new actuarial classes/tiers determined from such operating characteristics and behaviors. The present invention comprises an integrated system to extract via multiple sensors, screen, aggregate and apply for advertising rating purposes, data generated by the actual operation of the specific vehicle and the user/driver.

In accordance with the present invention, additional payments to the vehicle operators or charges to advertising clients can also be made based on data obtained from the vehicles, the advertising clients, and the events of the area where the vehicles are located will be available. For examples, the payments may be based on free tickets to vehicle owners or operators to a local event, restaurant or similar venue or location in exchange for having the vehicle present. An example of this would be to have a number of vehicles show up for a sporting event in exchange for free tickets to that event. Vehicle owners or operators may be advised of this payments via vehicle on-board computers, via the Internet, or any other means of communication including the telephone, mails, beepers, or PDAs, such as a palm-computing device.

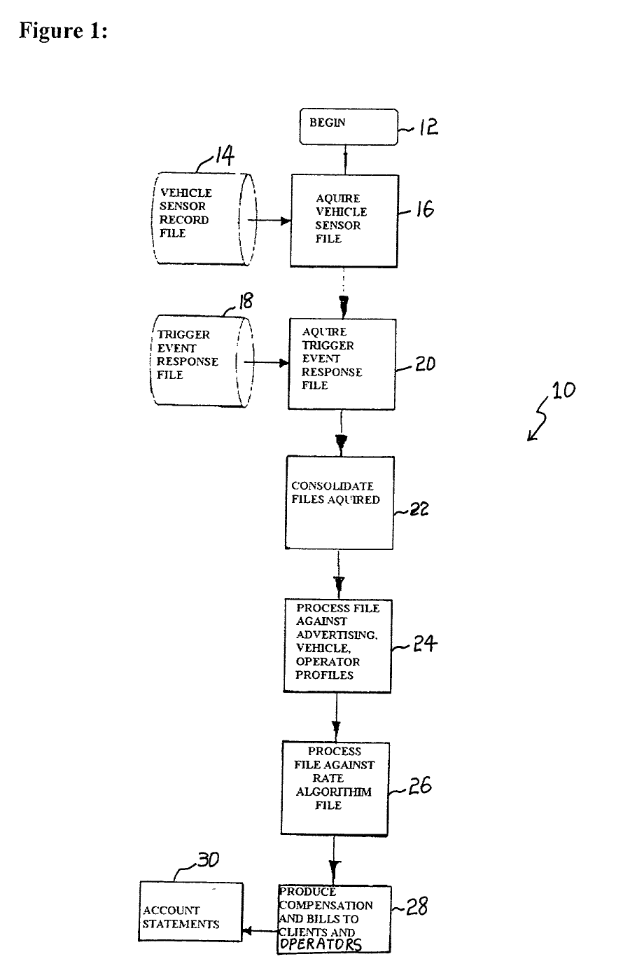

FIG. 1 shows flowchart 10 illustrating an aspect of the second embodiment in accordance with the present invention. In FIG. 1, a central control system (not shown) begins performing the present invention with respect to a selected vehicle by acquiring a vehicle sensor file in step 16. A vehicle trackingand-communication system installed in the vehicle generates and records the vehicle sensor file in step 14 and transmits the vehicle sensor file to the central control system via a satellite or other communication channels. The vehicle sensor file contains the vehicle operating characteristics, such as time, location, speed, or movement of the vehicle, etc. In step 18, a trigger event response file is generated either by the vehicle tracking-and-communication system or by other devices, events, or requests and is transmitted to the central control system in step 20. In step 22, the central control system compares and analyzes these two files and then processes an analyzed result from step 22 against a database containing information of advertising clients, registered vehicles, and profiles of vehicle operators, as shown in step 24. After matching a group of selected vehicles against an advertising client based on the predetermined advertising criteria, the central control system directs the selected vehicle(s) to display the advertisement requested by the advertising client. In step 26, the central control system processes data obtained from the vehicles and data stored in the database against a rate algorithm file of the central control system to determine compensation to the vehicle operators and charges to the advertising clients. Accordingly, the central control system produces compensation means, such as checks, to the vehicle operators and bills to the advertising clients in step 28. Finally, periodic account statements are sent to the vehicle operators and the advertising clients generated by the central control system in step 30.

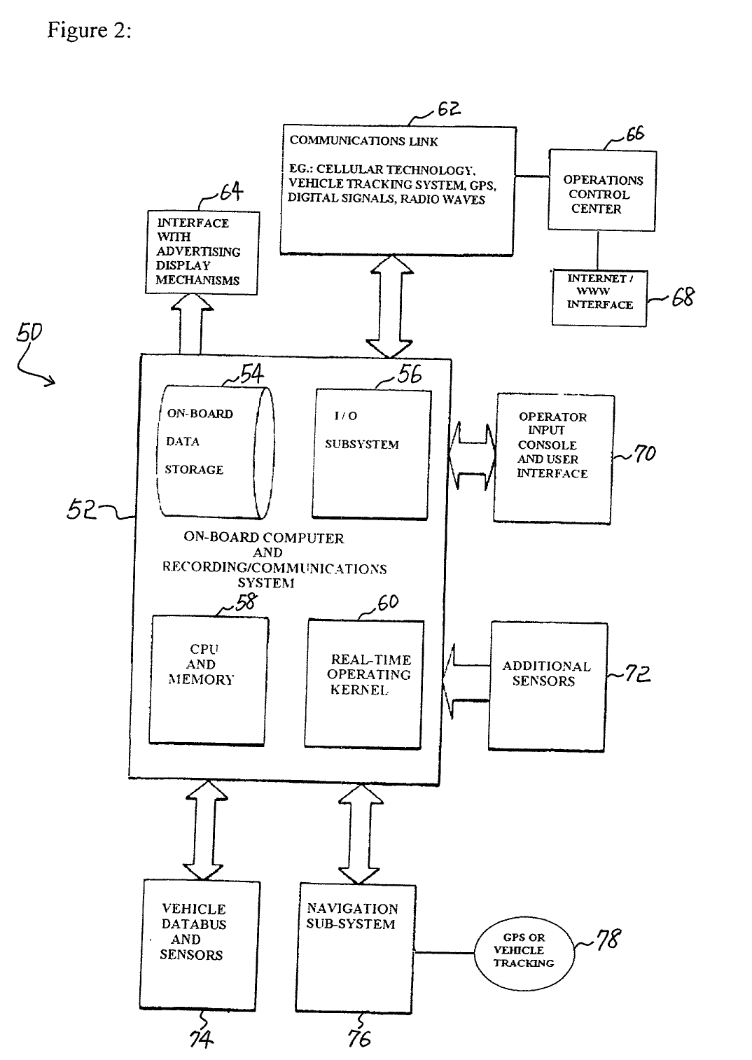

FIG. 2 shows a vehicle tracking-and-communication system 50 for communicating trigger events to the vehicles selected for advertising according to the second embodiment. The system 50 includes an on-board computer and recording/communications system 52. The on-board system 52 comprises on-board data storage 54, I/O subsystem 56, CPU and MEMORY unit 58, and real-time operating kernel 60. The on-board system 52 communicates with operations control center 66 of the central control system via communication link 62 to receive electronic signals from the central control system and communicates with the alterable material of the vehicle via interface 64 for directing the alterable material to display desired advertisements. The on-board system 52 can be manually controlled by the vehicle operator through operator input console and user interface 70. In addition, the on-board system 52 receives the vehicle operating characteristics via vehicle databus and sensors 74. The on-board system 52 communicates with a GPS or vehicle tracking system 78 through a navigation sub-system 76 in the vehicle to monitor movements and operations of the vehicle. Additional sensors 72 are also provided to the vehicle tracking-and-communication system 50 for determining information such as weather or light, etc.

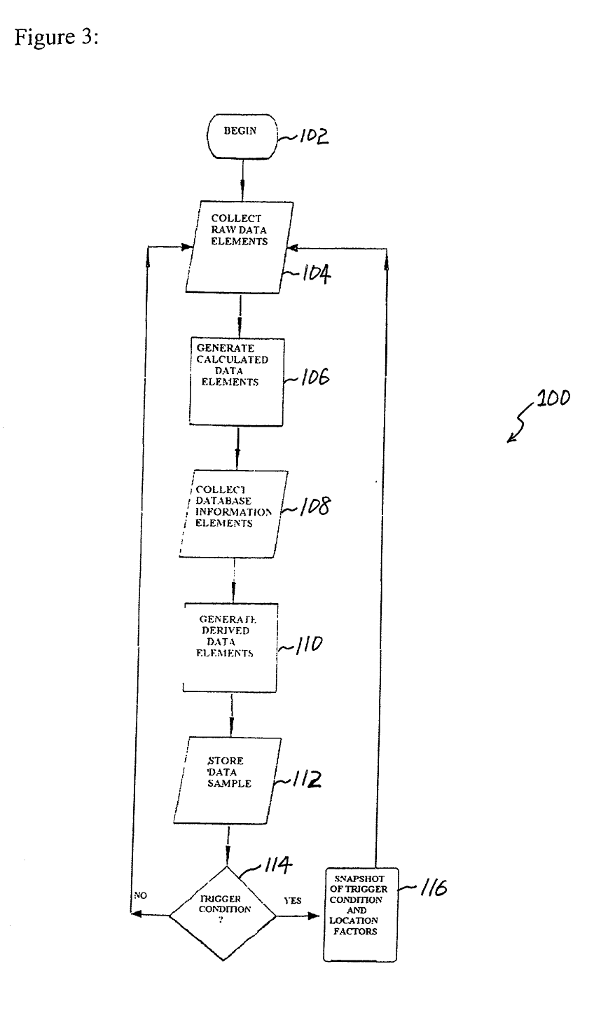

FIG. 3 shows flowchart 100 illustrating data processing according to the present invention. As shown in FIG. 3, the central control system first collects raw data elements in step 104. The raw data elements may be received from applications submitted by designated vehicle operators, obtained as vehicle operating characteristics from the vehicle tracking-and-communication system, received from advertising clients, or from MASP's own researches. The raw data elements are processed by the central control system in step 106 to generate calculated data elements of each vehicle operator, vehicle, and advertising client. In step 108, the calculated data elements are compared with information elements previously stored in the database. Subsequently, the central control system generates derived data elements in step 110 and then, in step 112, stores data samples in a storage device of the central control system. In step 114, the central control system thereafter decides whether or not a trigger condition has occurred. If a trigger condition has not occurred, the central control system continues collecting raw data elements back to step 104. If a trigger condition has occurred, the central control system evaluates the trigger condition and the current condition of the vehicle, such as the location of the vehicle, and directs the vehicle to respond by providing an advertisement according to the trigger condition, as shown in step 116. After that, the process is back to step 104 and starts all over again.

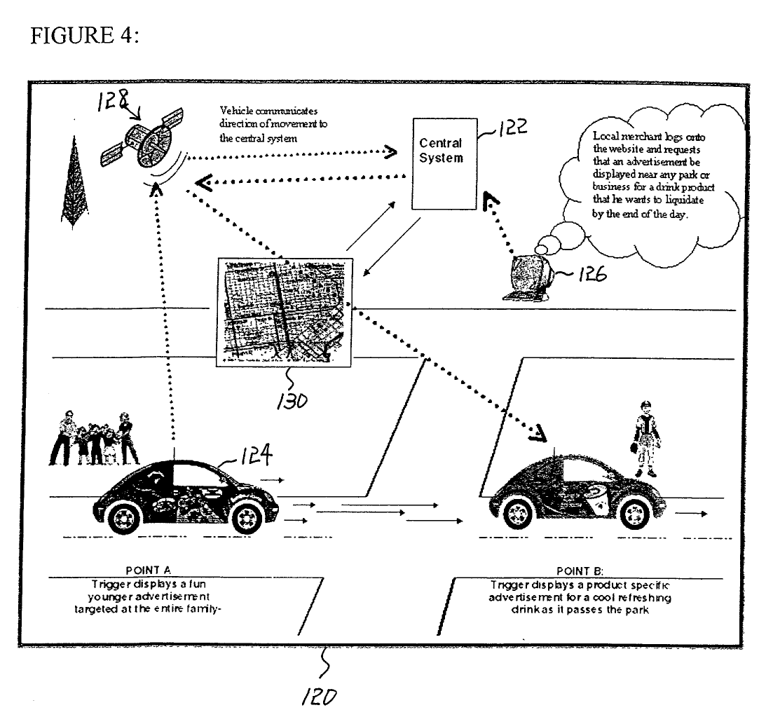

FIG. 4 illustrates an example of implementation according to the second embodiment of the present invention. In FIG. 4, local merchant 126 sends a request to central system 122 asking that an advertisement be displayed near any park or business for a drink product. The request may be sent via Internet, over the phone, or by any other communication channels. The central system 122 communicates the request to vehicle 124 via GPS satellite 128. Thus, when vehicle 124 is in point A, the alterable material of vehicle 124 displays a first advertisement. However, when vehicle 124 moves to point B, which is next to or near a park, the above-mentioned on-board system of the vehicle receives signals from the central system 122 to direct the alterable material to display the advertisement of the drink product.

In a third embodiment, the method according to the present invention may also provide a free or a substantially reduced cost vehicle to a designated vehicle operator. The designated vehicle operator is selected from a plurality of applicants based on information submitted by the applicants and by a plurality of advertising clients. After being selected, the designated vehicle operator signs a contract with the MASP detailing conditions of operating and of keeping the vehicle, of compensation for the vehicle operator, or of maintenance of the vehicle, etc. The vehicle is wrapped, covered or affixed with advertisement materials. After a predetermined period set by the MASP, the vehicle operator may acquire the vehicle from the MASP, with or without costs, or may simply return the vehicle to the MASP.

Other benefits and advantages of the present invention for mobile advertising and cost/compensation determination process will become apparent to those skilled in the art upon a reading and understanding of the specification. Therefore, the present invention is not limited to the above-mentioned embodiments and aspects. Accordingly, numerous changes can be make by persons skilled in the art without departing from the scope or principles of the present invention.

1. A method for providing outdoor mobile advertising, comprising the steps of:
generating vehicle information of a plurality of vehicles and storing the vehicle information in a database of a computer control system;
displaying an advertising material on each one or more vehicles selected from the plurality of vehicles in the database;
dynamically tracking and monitoring current vehicle operating characteristics and conditions of the selected vehicles, the current vehicle operating characteristics and conditions being used to update the selected vehicles' information in the database;
periodically compensating designated operators of the selected vehicles based on actual vehicle operating characteristics and conditions; and
periodically billing an advertising client at an advertising service rate for mobile advertising services provided to the advertising client, the advertising service rate being corresponding to compensation paid to the designated operators with added premium.

2. The method of claim 1, wherein the step of generating vehicle information comprises:
receiving applications from a plurality of potential candidates, the applications submitted by the potential candidates including predetermined detailed personal and/or vehicle data provided by the potential candidates;
storing information of the received applications in the database of the computer control system;
analyzing the data and categorizing the plurality of potential candidates into classes or tiers;
storing the analyzed and categorized data in the database of the computer control system.

3. The method of claim 2, further comprising the steps of
receiving a request from the advertising client, the request defining advertising criteria for an outdoor mobile advertising program; and
selecting one or more designated vehicle operators from the plurality of potential candidates for operating selected vehicles based on the advertising criteria and the analyzed and categorized vehicle information in the database.

4. The method of claim 1, wherein the selected vehicles are respectively installed an on-board vehicle tracking-and-communication system, the vehicle tracking-and-communication systems continuously tracking the vehicle operating characteristics and conditions and communicating with the computer control system for providing current vehicle operating characteristics and conditions to update the vehicle information in the database, the vehicle tracking-and-communication system being further adapted to send and/or receive electronic signals to/from the computer control system.

5. The method of claim 4, wherein the advertising materials displayed on at least some of the selected vehicles are adapted to display different advertising messages in response to the electronic signals received either from the computer control system or from an on-board computer system.

6. The method of claim 5, further comprising the steps of:
receiving an advertising request from the advertising client to the computer control system;
defining a trigger event for displaying an advertising message based on the advertising request;
analyzing current vehicle operating characteristics and conditions of selected vehicles;
matching and selecting one or more specific vehicles based on the trigger event and the current vehicle operating characteristics and conditions; and
sending an electronic signal to the specific vehicles by the computer control system directing the advertising material of each of the specific vehicle to display the advertising message according to the advertising request.

7. The method of claim 6, wherein the advertising request from the advertising client may be received by the computer control system through the Internet, telephone, email, mail, in person, other communication channels, or any combination thereof.

8. The method of claim 4, wherein the advertising material is an electronic paper, an electronic or electrical billboard, or any other alterable materials adapted to change messages displayed thereon.

9. The method of claim 1, wherein the advertising material is made of materials such as vinyl adhesive wrap, paper or plastic sticker, paint, product model, metal, glass, plastics, electronic or electrical billboard, any combination thereof, or any material that is suitable for advertising purposes.

10. A system for providing outdoor mobile advertising, comprising:
a central computer system, said central computer system being adapted to receive and store vehicle and operator/owner information in a database and to select vehicles designated for mobile advertising from the vehicle and operator information;
an on-board vehicle tracking-and-communication system installed on each of the selected vehicles, said on-board vehicle tracking-and-communication system being adapted to continuously track, monitor and update vehicle operating characteristics of the selected vehicle and being adapted to communicate with said central computer system by sending and/or receiving electronic signals; and
an advertising material displayed on each of the selected vehicles, said advertising material displaying one or more advertising messages for one or more advertising clients wherein the central computer system periodically updates the vehicle and operator/owner information in the database based on actual vehicle operating characteristics received from the on-board vehicle tracking-and-communication system and periodically generates a compensation report to each operator/owner of the selected vehicles and a billing report to each advertising client for mobile advertising services provided.

11. The system of claim 10, wherein the advertising material is made of materials such as vinyl adhesive wrap, paper or plastic sticker, paint, product model, metal, glass, plastics, electronic or electrical billboard, any combination thereof, or any material that is suitable for advertising purposes.

12. The system of claim 10, wherein the advertising materials displayed on at least some of the selected vehicles are adapted to display different advertising messages in response to the electronic signals received either from the central computer system or from an on-board computer system.

13. The system of claim 12, wherein, in response to a trigger event, the central computer system sends an electronic signal to a specific vehicle having the advertising material adapted to display different messages for displaying an advertising message according to the trigger event.

14. The system of claim 13, wherein the trigger event is determined by a request received from an advertising client and by current vehicle operating characteristics of the specific vehicle.

15. The system of claim 12, wherein each of the advertising material adapted to display different advertising messages is an electronic paper, an electronic or electrical billboard, or any other alterable materials adapted to change messages displayed thereon.

16. The system of claim 10, wherein the periodic compensation paid to each vehicle operator/owner is made in accordance with actual vehicle operating characteristics within a predetermined period and an advertising service fee in the periodic billing report charged to each advertising client is corresponding to the compensation paid to operators/owners with added premium.

17. A method for providing outdoor mobile advertising, comprising the steps of:
publicizing the availability of vehicles at substantially reduced costs to potential operators and requesting specific information from such potential operators;
receiving such specific request information from potential operators, the specific information from a plurality of potential operators being stored in a database of a computer server system;
defining criteria for an outdoor vehicle-advertising program;
selecting designated operators by employing the advertising criteria and the potential operator specific information database; and
providing a vehicle to the designated operators at substantially reduced costs, the vehicle being displayed with an advertising material pursuant to the advertising program and being installed an on-board vehicle tracking-and-communication system for sending and/or receiving electronic signals to/from the computer server system.

18. The method of claim 17, further comprising the steps of:
dynamically tracking, monitoring and recording the operating characteristics of the vehicle by the on-board vehicle tracking-and-communication system; and
updating the operating characteristics of the vehicle in the computer server system database.

19. The method of claim 18, wherein the advertising material displayed on the vehicle is adapted to display different advertising messages in response to electronic signals received from the computer server system.

20. The method of claim 19, further comprising the steps of:
receiving an advertising request from an advertiser by the computer server system;
determining a trigger event based on the advertising request and the current vehicle operating characteristics of the vehicle; and
sending an electronic signal by the computer server system to the vehicle for directing the advertising material to display an advertisement in accordance with the advertising request if the trigger event is satisfied.
